(19) United States
(12) Patent Application Publication
(10) Pub. No.: US 2015/0372950 A1
(43) Pub. Date: Dec. 24, 2015

(54) METHOD AND SYSTEM FOR AUTOMATED VERIFICATION OF SENTIENCE USING AN ELECTRONIC COMMUNICATION PROTOCOL

(71) Applicant: Richard Parks, Concord, CA (US)

(72) Inventor: Richard Parks, Concord, CA (US)

(21) Appl. No.: 14/696,397

(22) Filed: Apr. 25, 2015

Related U.S. Application Data
(60) Provisional application No. 62/013,637, filed on Jun. 18, 2014.

(51) Int. Cl. H04L 12/58; G06Q 40/08; G06Q 40/06

(52) U.S. Cl. CPC H04L 51/02; G06Q 40/06; G06Q 40/08

(57) ABSTRACT

A method and system for automatically verifying that a user is still sentient and alive by implementing a user-specified protocol of timed electronic communications is disclosed. In use, a user is previously assigned or themselves sets up a protocol of electronic communications to be sent at specified timed intervals. These sent timed electronic communications may be in the form of a “ping” or some sort of telecommunication alert that requires a user response. More specifically, for each “ping” or alert, the user must respond within a specified period of time. If the user responds, the protocol is terminated and starts over at the beginning. If the user does not respond within the specified time, the protocol proceeds to the next communication. If the protocol completes without any response from the user, a user designated person or guardian is alerted.

### CROSS-REFERENCE TO RELATED APPLICATIONS

This application claims priority to U.S. Provisional Application Ser. No. 62/013637, filed Jun. 18, 2014, entitled “METHOD AND SYSTEM FOR AUTOMATED VERIFICATION OF SENTIENCE USING AN ELECTRONIC COMMUNICATION PROTOCOL” the contents of which are incorporated herein by reference in their entirety.

### TECHNICAL FIELD

This present invention relates, in general, to electronic communications and, in particular, to a method and system for the selective automatic electronic transmission of personal data upon the death of a person.

### BACKGROUND ART

Currently, many banks, financial institutions, and insurance companies retain hundreds of billions of dollars in unclaimed assets. According to recent estimates, the proceeds of one in four life insurance policies remain unclaimed, and about sixteen (16) billion dollars of matured United States savings bonds remain unclaimed. These and other investments often remain unclaimed because the beneficiaries of a deceased benefactor are unaware of the death and/or of the existence of the investment.

Many living persons would like to communicate messages to certain individuals, but do not wish to do so while their alive. A person's will maybe written to include instructions to convey certain types of messages to individuals during the probate process, but a will is not a widely or publicly circulated document and has limited flexibility for such a purpose. Software agents exist for allowing individuals to electronically delegate tasks to be performed at a future date. However, these tasks are typically initiated when a pre-programmed date occurs, not as a result of a condition occurring with respect to the individual who orders the tasks, such as the death of the that person.

Prior art computer-implemented systems exist for tracking the mortality of individuals and notifying beneficiaries of the death of the benefactor. In certain regards, mortality tracking involves determining sentient information, i.e. whether an individual is alive or deceased. However, these systems may be prone to error since the data used for tracking is often unreliable. Moreover, these systems often passively track the sentience of individuals. Consequently, the mortality information is gathered in an untimely and inefficient manner. The present invention solves this and many other problems in a novel and unique manner.

### SUMMARY OF THE INVENTION

A method and system for automatically verifying that a user is still sentient and alive by implementing a user-specified protocol of timed electronic communications is disclosed. In use, a user is previously assigned or themselves sets up a protocol of electronic communications to be sent at specified timed intervals. These sent timed electronic communications may be in the form of a “ping” or some sort of telecommunication alert that requires a user response. More specifically, for each “ping” or alert, the user must respond within a specified period of time. If the user responds, the protocol is terminated and starts over at the beginning. If the user does not respond within the specified time, the protocol proceeds to the next communication. If the protocol completes without any response from the user, a user designated person or guardian is alerted.

### DESCRIPTION OF THE DRAWINGS

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention. In the accompanying drawings:

FIG. 1 is a system block diagram for automatically verifying that a user is still sentient and alive by using telecommunications in association with software protocols controlled by a server in accordance with the present invention; and

FIG. 2 is a flowchart illustrating the process steps for a method of automatically verifying that a user is still sentient and alive by implementing a user-specified protocol of timed electronic communications in accordance with the present invention.

### DESCRIPTION OF EMBODIMENTS

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention

Reference will now be made in detail to embodiments, methods and systems of the present invention known to the inventor. However, it should be understood that disclosed embodiments are merely exemplary of the present invention which may be embodied in various and alternative forms. Therefore, specific details disclosed herein are not to be interpreted as limiting, rather merely as representative bases for teaching one skilled in the art to variously employ the present invention.

A computer-implemented system is provided such that an individual may secure and manage their personal information. In a preferred embodiment, the individual is a monitored individual. Moreover, the computer-implemented system monitors the mortality or sentience of the monitored individual. Personal information may refer to any information the monitored individual may use in their lives. Non-limiting examples of personal information may include financial, estate and investment information.

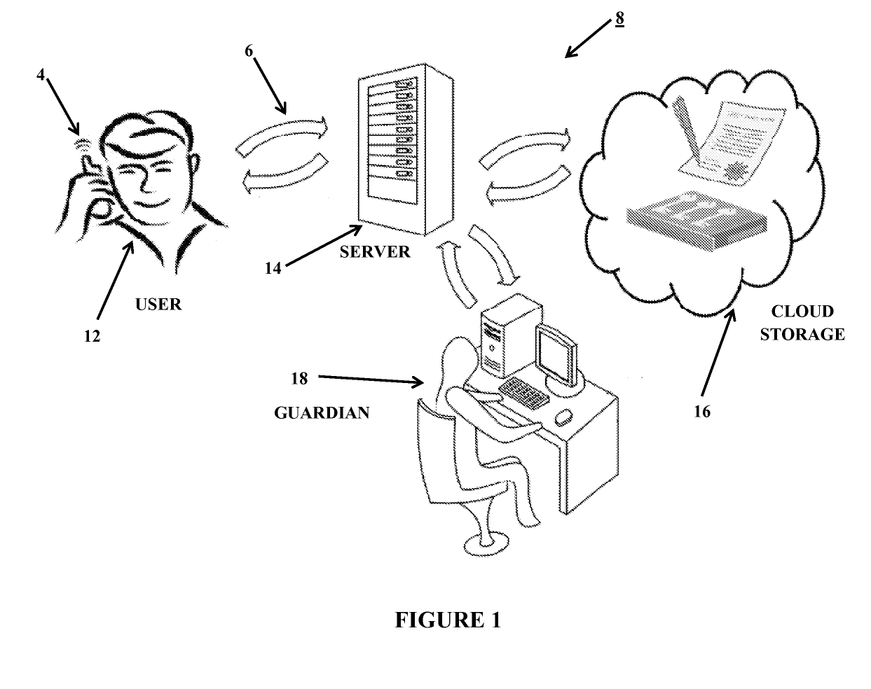

Referring now to FIG. 1 there is shown a block diagram illustrating the computer-implemented system 8 according to one embodiment of the present invention for managing personal information. The computer-implemented system 8 may be referred to as a personal estate manager system. The computer-implemented system 8 may be a personal computer, for example, a desktop or notebook computer and in a preferred embodiment is a server computer 14 as shown in FIG. 1. The server computer 14 may be connected to a computer network, for example a local area network (LAN) or a wide area network (WAN), through a variety of interfaces, including, but not limited to dial-in connections, cable modems, high-speed lines, and hybrids thereof. Turning once again to FIG. 1, a user 12 may be connected using their personal electronic communications device 4 to server computer 14 through communication lines or through the Internet 6. Server computer 14 may be a database server, an application server, a web server, a directory server, a mail server, and/or hybrids thereof. It will be apparent that the type of server computer 14 depends on the nature and implementation of computer system 8.

It should be understood that server computer 14 supports TCP/IP protocol having input and access capabilities via two-way communication line 6. Another non-limiting example of a supportable protocol is voice over Internet protocol, otherwise referred to as VOIP. Therefore, communication line 6 are intranet-adaptable communication lines, for example, a dedicated line, a satellite link, an Ethernet link, a public telephone network, a private telephone network, and hybrids thereof. Communication line 6 is adaptable to connect to the Internet. Examples of suitable communication lines include, but are not limited to, public telephone networks, public cable networks, and hybrids thereof. It is understood that communication line 6 may be purely Internet-adaptable or intranet-adaptable or hybrids thereof. For example, communication line 6 may include an Internet-adaptable portion and an intranet-adaptable portion.

Turning once again to FIG. 1, the user 12 begins by having assigned or themselves setting up a protocol of electronic communications that is managed by server computer 14. Once the protocol is received by server computer 18, control of the mortality tracking system may begin at the request of the user 12. As part of the protocol for example, server computer 14 may host a GUI to prompt the user to enter a unique identifier, for example, a previously set password wherein the GUI may be sent to a previously defined to the user's communication device of choice which by way of example may be a smartphone 4 as depicted in FIG. 1. Additionally, as part of the initial protocol set up, the users' personal information may be stored in server 14 or cloud storage 16 for security purposes to be sent to a guardian 18 upon the user's death as will be more fully described below.

Also it should be understood that the computer-implemented system 8 may be online, offline, or a blend thereof (not shown). The computer-implemented system 8 may be embodied in stand-alone computer software. The computer-implemented system 8 may include the participation of one or more individuals, for example, a personal estate manager, their lawyer, CPA, a close friend, spouse, children or relative for supporting and maintaining different aspects of the system. According to one aspect of the present invention, the monitored individual can identify one or more access these individuals, sometimes referred to as guardians, to receive at least some, if not all of, the monitored individual's personal information upon the occurrence of an event, for example, death or incapacity of the monitored individual. In accordance with the present invention the system has the capability of automatic and/or continuous mortality tracking of the monitored individual so that the guardians may be notified of the individual's death in a timely manner. It should be understood that mortality tracking may also be conducted on an intermittent basis, for example, checking a mortality database regularly with short intervals between succession tracking.

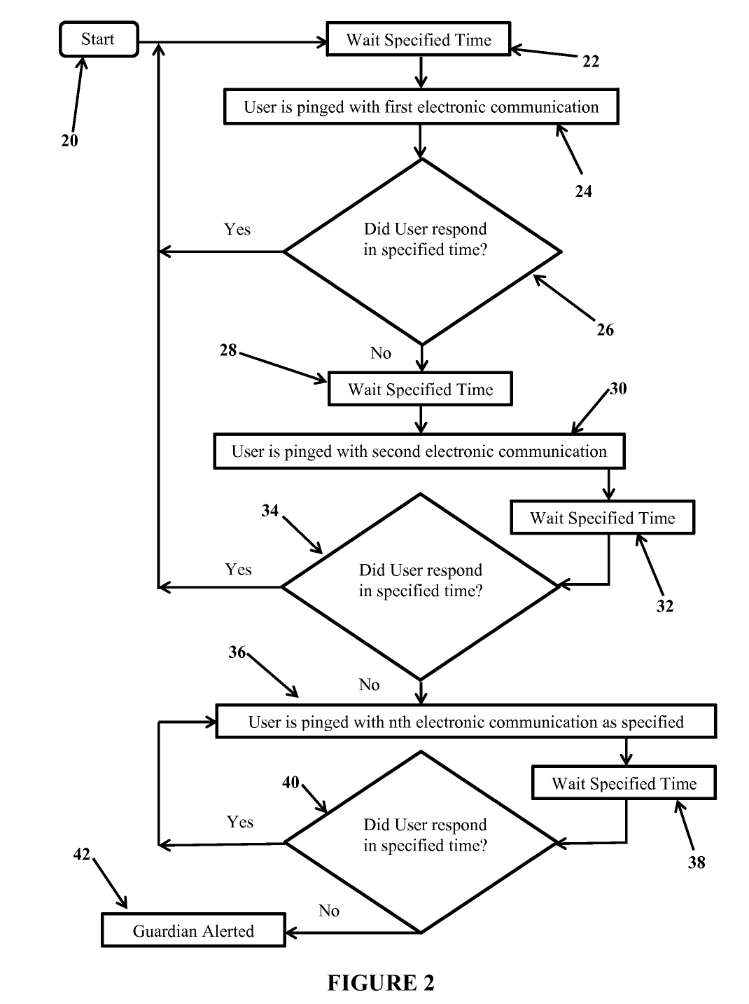

Referring now to FIG. 2 there is shown a flowchart illustrating the process steps for a method of automatically verifying that a user is still sentient and alive by implementing a user-specified protocol of timed electronic communications in accordance with the present invention. First, the user begins by having assigned or themselves setting up a protocol of electronic communications and then starts 20 the protocol. It should be understood that at any time the user may interrupt this protocol such as when they go on vacation or leave the country for business purposes or the like. Turning once again to FIG. 2, once the protocol is started a specified time initially passes 22. After this initial time period expires the user is pinged with a first electronic communication 24 to their electronic communication device of choice they initially identified when they set up the process. The protocol then determines if the user responded to the ping at the specified time 26. If they did, the protocol once again waits a specified time 28. As before the user is pinged again with a second electronic communication 30. The protocol once again waits a specified time 32. The protocol once again determines if the user responded to the ping at the specified time 34. If they did the process starts over at step 22. If not the user is pinged n number of times in accordance to how the user initially set up their personalized protocol where n is an integer value. The pinging continues as long as the user responds until no response is received wherein their designated guardian is alerted and the user's personal information that was previously placed in computer memory storage such as a cloud system is also sent to the guardian.

By way of example but not of limitation, an individual named John Doe has subscribed to the service and has accepted the default protocol. For the normal case, i.e., John Doe is still sentient; he will receive an email showing a button that he must press to confirm his continued existence. If he presses that button, the system will wait another week to send him another verification email and so on as long as he answers each initial email in two days' time. However, if he fails to respond to an initial email for two days the system will follow up with a second email that also shows a button allowing confirmation of his existence. If John does not respond to the second email, there is a third step to this default protocol which sends John a text message requesting confirmation of his existence. If John does not respond to this text message for two days, which is the final step of the protocol, then his indicated guardian (for example, his wife) will be sent an email with a name and password allowing her to access his cloud-based information vault.

In summary, a method and system for automatically verifying that an individual is still sentient and alive by implementing a user-specified protocol of timed electronic communications has been described. In use, the individual previously assigns or themselves sets up a protocol of electronic communications to be sent at specified timed intervals back to themselves. These sent timed electronic communications may be in the form of a “ping” or some sort of telecommunication alert that requires the individual to respond. More specifically, for each “ping” or alert, the individual must respond within a specified period of time. If the individual responds, the protocol is terminated and starts over at the beginning If the individual does not respond within the specified time, the protocol proceeds to the next communication. If the protocol completes without any response from the individual, a designated person or guardian is then alerted and certain messages from the individual are then transmitted to their designated person or guardian.

It is contemplated for embodiments of the invention to extend to individual elements and concepts described herein, independently of other concepts, ideas or system, as well as for embodiments to include combinations of elements recited anywhere in this application. Although illustrative embodiments of the invention have been described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. This, the absence of describing combinations should not preclude the inventor from claiming rights to such combinations.

In general, the routines executed to implement the embodiments of the invention, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of machine or computer-readable media used to actually effect the distribution. Examples of computer-readable media include but are not limited to recordable type media such as volatile and non-volatile memory devices, USB and other removable media, hard disk drives, optical disks (e.g., Compact Disk Read-Only Memory (CD ROMS), Digital Versatile Disks, (DVDs), etc.), and flash drives, among others.

Although the present invention has been described with reference to specific exemplary embodiments, it will be evident that the various modification and changes can be made to these embodiments without departing from the broader spirit of the invention. Accordingly, the specification and drawings are to be regarded in an illustrative sense rather than in a restrictive sense.

What is claimed is:

1. A method for automatically verifying that a user is still sentient and alive by implementing a user-specified protocol of timed electronic communications comprising the steps of:
a) setting up a protocol of electronic communications to be sent at specified timed intervals to a designated user;
b) sending said timed electronic communications in the form of a telecommunication alert that requires a user response;
c) determining if said individual has responded wherein if the user has responded said protocol is terminated and return to step “a” for setting up a new protocol call for the user;
d) determining if the user has not responded said protocol proceeds to a next communication;
e) determining if said protocol completes without any response from the user, wherein a user designated person is alerted.

2. The method of claim 1 further comprising the step of interrupting said protocol by the user when they go on vacation.

3. The method of claim 1 further comprising the step of interrupting said protocol by the user when they leave the country for business purposes.

4. The method of claim 1 further comprising the step of determining if said protocol completes without any response from the user, wherein a user designated guardian is alerted.

5. A system for automatically verifying that a user is still sentient and alive comprising:
computer software for implementing a user-specified protocol of timed electronic communications,
said protocol of electronic communications to be sent at specified timed intervals;
said timed electronic communications sends a telecommunication alert that requires a user response wherein the user must respond within a specified period of time; and
the user responding to said alert terminates the protocol wherein if the user does not respond within the specified time, the protocol proceeds to the next communication wherein if the protocol completes without any response from the user, a user designated person is alerted.

6. The system of claim 5 further comprising interrupting said protocol is interrupted by the user when they go on vacation.

7. The system of claim 5 further comprising said protocol is interrupted by the user when they leave the country for business purposes.

8. The system of claim 5 further comprising said user designated person is a user designated guardian.

9. The system of claim 5 further comprising said user is assigned said protocol by a designated person.

10. The system of claim 5 further comprising said user is assigned said protocol by a designated guardian.

11. The system of claim 5 further comprising said user assigns said protocol by themselves.

12. The system of claim 5 further comprising telecommunication alerts are in the form of a “ping”.
